(19) United States
(12) Patent Application Publication
(10) Pub. No.: US 2023/0267321 A1
(43) Pub. Date: Aug. 24, 2023

(54) VIABILITY DETERMINATION WITH SELF-ATTENTION FOR PROCESS OPTIMIZATION

(71) Applicant: Siemens Healthcare GmbH, Erlangen (DE)

(72) Inventors: Ramya Vunikili, Secaucus, NJ (US); Vivek Singh, Princeton, NJ (US); Oladimeji Farri, Upper Saddle River, NJ (US); Supriya H N, Tumkur (IN); Jashwanth N B, Mysore (IN); Malte Tschentscher, Erlangen (DE); Jens Uecker, Uttenreuth (DE); Jens Fürst, Herzogenaurach (DE); Jens Bernhardt, Erlangen (DE)

(21) Appl. No.: 17/652,288

(22) Filed: Feb. 24, 2022

(51) Int. Cl. G06N 3/08; G06N 3/04; G06K 9/62

(52) U.S. Cl. CPC G06N 3/08; G06N 3/0454; G06K 9/6215

(57) ABSTRACT

For viability determination with self-attention for process optimization, various process and state information in the manufacture (e.g., forming, assembling, and/or handling) of a part are embedded. A machine-learned model generates the embedding, which is used with self-attention similarity to identify similar cases based on the embedding. The model was trained using both regression for continuous information (e.g., variable names) in the embedding and classification for non-continuous information (e.g., value of a variable) in the embedding. By including both regression and classification, the same machine-learned model may be used for reliable and nuanced viability determination.

### BACKGROUND

The present embodiments relate to viability determination for a manufactured device, such as prediction of lifetime of a part. When an X-Ray tube fails at the customer site, a field engineer analyses the root cause of the failure and services the faulty part of the tube or replaces the entire tube. Expertise and technical know-how acquired by the field engineer are used in servicing the part. However, this requires that the part fail where it would have been better to pre-emptively replace the part or even not provide the faulty part in the first place.

Faulty X-ray tubes may be separated from viable X-ray tubes pre-emptively by estimating the tube lifetime using data obtained from several manufacturing and/or testing processes. Each X-ray tube is formed from a cathode and an anode that are enclosed in a vacuum assembly called the X-ray tube assembly (XTA). An XTA failure can occur due to any glitches in (i) the manufacturing of cathode, anode, or their subcomponents, (ii) assembling process, or (iii) due to external factors. Using testing, faulty XTAs may not be used. Simple testing may not accurately predict lifetime, faulty from viable, or other viability.

### SUMMARY

In various embodiments, systems, methods, and non-transitory computer readable media are provided for viability determination with self-attention for process optimization. Various process and state information in the manufacture (e.g., forming, assembling, and/or handling) of a part are embedded. A machine-learned model generates the embedding, which is used with self-attention similarity to identify similar cases based on the embedding. The model was trained using both regression for continuous information (e.g., variable names) in the embedding and classification for non-continuous information (e.g., value of a variable) in the embedding. By including both regression and classification, the same machine-learned model may be used for reliable and nuanced viability determination.

In a first aspect, a method is provided for viability determination. Process parameters and state parameters of a manufactured device are received. A machine-learned self-attention model is applied to the process parameters and state parameters. The machine-learned self-attention model was trained with regression for some of the process and/or state parameters and classification for others of the process and/or state parameters. Viability of the manufactured device is determined based on output of the machine-learned self-attention model in response to the applying. The viability is output.

In one embodiment, the lifetime of the manufactured device is determined as the viability. In another embodiment, the manufactured device is a component of an x-ray tube assembly or the x-ray tube assembly.

The output from the applying may be an embedding. Various embodiments of embedding are provided. For example, the embedding is a sequential tabulation of process variables and process values for the process variables as the process parameters and of state variables and state values for the state variables as the state parameters. The process variables are manufacturing and/or testing processes and the state variables are state of the manufactured device during and/or after processing to manufacture. As another example, one or more of the process parameters and/or state parameters are embedded multiple times. In yet another example, positional encoding of the process parameters and the state parameters is included in the embedding. As another example, the embedding is performed for each of multiple components, and the process parameters and state parameters for each of the multiple components are embedded into a common embedding for the manufactured device with labels in the common embedding for the components. A token may be included as part of the embedding at a beginning of the embedding for each of the components. The token identifies the component and the process and state parameters for that component following the token in the common embedding.

In one embodiment, a vocabulary with assigned numerical identifiers representing text is used. The process and state parameters are embedded as parameter variables and parameter values in a same space with the variables encoded numerically with numerical values distinguishing from the parameter values. The process and state parameters include both continuous and non-continuous representations.

In another embodiment, the applied machine-learned self-attention model is a transformer neural network.

In other embodiments, the machine-learned self-attention model was trained with regression by masked value regression and was trained with classification by masked variable classification. For example, in the training, the masked value regression masked continuous values to train the self-attention model to predict the masked continuous values, and the masked variable classification masked parameter variables while exposing the continuous values to train the self-attention model to predict the masked parameter variables. The training is sequential with respect to the regression and classification. In a further embodiment, discriminator training was included in the sequence. The machine-learned self-attention model was further trained as a generator of a generative adversarial network including a discriminator sequentially trained with the regression and with the classification.

According to one embodiment, the output is an embedding with self-attention-based similarity, from which historic examples are identified. The viability is determined from the historic examples.

In another embodiment, the determination of viability is performed with a machine-learned viability model based on input of similar cases identified by the applying.

As another embodiment, a subset of the process and/or state parameters are identified based on influence of the viability. The subset of the process and/or state parameters influencing the viability are output.

In a second aspect, a system is provided for similarity searching for a part. A memory is configured to store a machine-learned model. The machine-learned model is a transformer neural network configured to identify an embedding used for finding similar cases based on self-attention similarity for both non-continuous variables and continuous values. The same transformer neural network was trained with regression for the continuous values and classification for the non-continuous variables. A processor is configured to apply both the continuous values and the non-continuous variables for the part to the machine-learned model, resulting in inference by the machine-learned model of the embedding. The processor is configured to identify similar cases from the embedding.

In a third aspect, a method is provided for machine training for similarity. A machine trains a neural network with masked value regression to predict continuous values in an embedding including both the continuous values and non-continuous variables representing process and state parameters for a manufactured piece. The masked value regression uses a self-attention similarity. The machine also trains the neural network with masked variable classification to predict the non-continuous variables in the embedding. The masked variable classification uses the self-attention similarity. The machine-trained neural network is stored.

In one embodiment, the training with masked value regression includes training with the non-continuous variables exposed, and the training with the masked variable classification includes training with the continuous values exposed. The neural network is a transformer network as a self-attention-based encoder.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 is a block diagram of one embodiment of a system for similarity searching for a part;

FIG. 2 is a flow chart diagram of one embodiment of a method for viability determination with a model trained for both regression and classification;

FIG. 3 is an example of a portion of embedding for a component;

FIG. 4 is an example of a portion of embedding for an assembly of multiple components;

FIG. 5 is a flow chart diagram of one embodiment of a method for machine training for similarity; and

FIG. 6 illustrates self-attention modeling.

### DETAILED DESCRIPTION OF EMBODIMENTS

For a deep process optimizer (i.e., machine-learned network for a manufacturing process), self-attention is leveraged. Manufacturing (e.g., forming, assembling, and/or testing) process parameters can be used to define the state of a part, and these process parameters together with the state parameters can act as a deterministic input for the prediction of viability, such as prediction of the lifetime, using machine learning or deep learning algorithms.

In the examples used herein, the part is a component of an XTA (e.g., cathode, anode, tube, connectors, and/or sub-components). Similarly, for embodiments using a single component, the cathode is used as an example. In other embodiments, other types of parts (e.g., computer chips, robotic arm, . . . etc.) formed using similar or different processes may benefit from viability determination.

The lifetime or other viability prediction may be explained by tracing the viability estimate back to the most contributing N features of the process data, where N is an integer of 1 or greater. The viability determination leverages a self-attention mechanism for capturing the correlations between various process and state values and parameters of the part or manufactured piece (e.g., XTA or cathode). By optimizing the features that are having an adverse effect on the viability (e.g., lifetime of XTA), the product quality can be increased and, thus, the cost savings on the warranty or servicing of the part can be improved.

The self-attention model is included in a model for estimating viability, such as a neural network. In one embodiment, a transformer network is used. Rather than using a separate model for classification and regression tasks, both classification and regression are used together for the model. By embedding of the information for classification with information for regression together, both classification and regression may be used in the training. By separating the continuous variables from the categorical values and yet representing them in the same embedding space, both regression and classification are performed simultaneously using the trained self-attention-based encoder.

FIG. 1 shows one embodiment of a system for similarity searching for a part. A machine-learned (ML) model 114 identifies similar cases based on self-attention for viability determination. The machine-learned model 114 was trained with both regression and classification to operate on an embedding for the part that includes both continuous and non-continuous (categorical) parameters. Parameters may be labels (e.g., token or component name), variables (e.g., name of variable), and/or values (e.g., numerical values for a variable). The variables and values are for process (e.g., forming an emitter by electroplating as the variable with M voltage as the numerical value) and/or state (thickness as the variable with P millimeters as the numerical value).

The system includes a processor 102, a memory 104, and a display 106. For example, the system is a computer, workstation, and/or server. Additional, different, or fewer components may be provided. For example, an interface for communications with a database, server, or other computer are provided. Various peripheral devices such as, for example, a disk storage device (e.g., a magnetic or optical disk storage device), a keyboard, a printing device, and/or a mouse, may be operatively coupled to the processor 102. A program may be uploaded to, and executed by, the processor 102. Likewise, processing strategies may include multiprocessing, multitasking, parallel processing, and the like. The processor 102 is implemented on a computer platform having hardware such as one or more central processing units (CPU), a random-access memory (RAM), and input/output (I/O) interface(s). The computer platform also includes an operating system and microinstruction code.

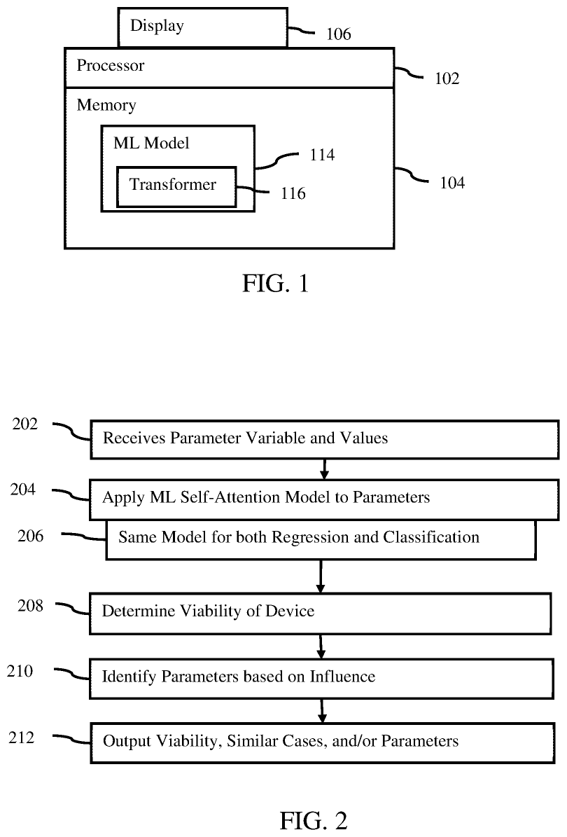

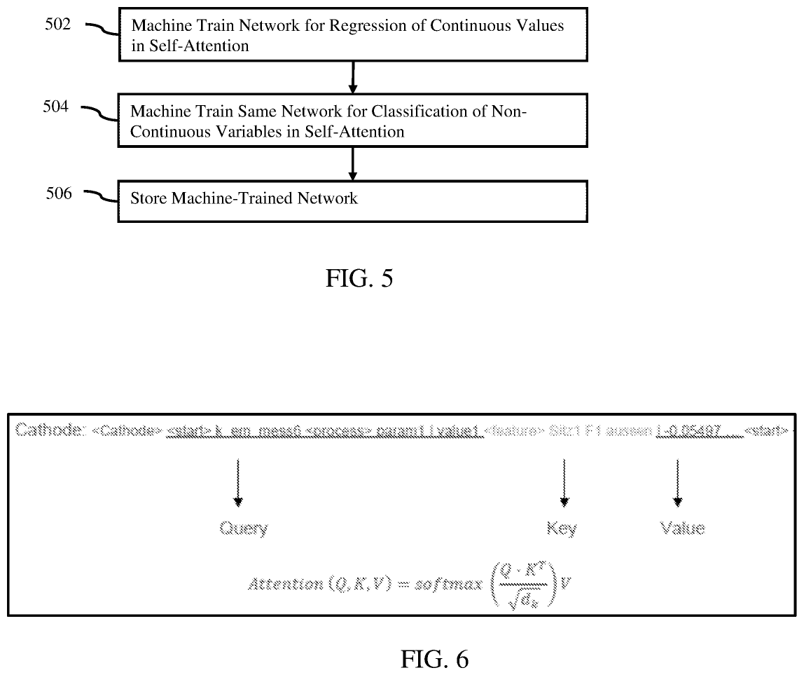

The system implements the methods of FIG. 2 or 5. Other acts or methods may be implemented by the system.

The memory 104 is a non-transitory memory. The memory 104 is an external storage device, RAM, ROM, memory stick, and/or a local memory (e.g., solid state drive or hard drive). The memory 104 may be implemented using a database management system (DBMS) managed by the processor 102. Alternatively, the memory 104 is internal to the processor 102 (e.g., cache). The memory 104 is configured by the processor 102 or other device to store and provide data. The same or different computer readable media may be used for instructions for the processor 102 and other data.

The memory 104 is configured to store the machine-learned model 114. For example, the machine-learned model 114 is a transformer neural network 116 configured to identify similar cases based on self-attention similarity. Based on training, the transformer network is configured to identify using both non-continuous variables and continuous values. The same transformer neural network 116 was trained with regression for the continuous values and classification for the non-continuous variables. Non-continuous values and/or continuous variables may be used. Any combination of process and/or state parameters may be used.

A database of embeddings or records for other parts of the same or similar type may be stored by the memory 104. The memory 104 may store determined viability, identified parameters influencing viability, and/or outputs. The historical cases for identifying similar embeddings are stored.

The computer processing performed by the processor 102 may be implemented in various forms of hardware, software, firmware, special purpose processors, or a combination thereof. Some embodiments are implemented in software as a program tangibly embodied on a non-transitory program storage device (e.g., the memory 104). By implementing with a system or program, instructions for similarity matching and/or viability determination may be provided. The functions, acts, or tasks illustrated in the figures or described herein are executed in response to one or more sets of instructions stored in or on the non-transitory computer readable storage media. The functions, acts, or tasks are independent of the particular type of instructions set, storage media, processor, or processing strategy and may be performed by software, hardware, integrated circuits, firmware, microcode, and the like, operating alone or in combination.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system. Because some of the constituent system components and method steps depicted in the accompanying figures are preferably implemented in software, the actual connections between the system components (or the process steps) may differ depending upon the manner in which the present embodiments are programmed.

The processor 102 is configured to apply an embedding of both the continuous and non-continuous parameters (e.g., continuous values and non-continuous variables) for the part to the machine-learned model 114. The machine-learned model 114, in response to input of the embedding, infers similar cases and/or viability. In one embodiment, the processor 102 applies the machine-learned model 114 to identify historical parts with similar embedding. Any number of such similar cases may be identified, such as the most similar R cases or instances of the part where R is an integer of 1 or greater. Information from those similar cases may be used to determine viability, such as an average lifespan of those historical instances of the part.

FIG. 2 shows one embodiment of a flow chart for a method for viability determination. The viability of a manufactured device (e.g., part), such as a component (e.g., cathode) or assembly (e.g., XTA) is determined. A machine-learned self-attention model is applied to an embedding for the device to determine the viability and/or identify similar cases from which the viability is determined.

The method is performed by the system of FIG. 1 or a different system. For example, a processor forms or accesses the embedding from a memory, applies the model, determines the viability, and identifies parameters. A display, in conjunction with the processor, outputs the viability, similar cases, and/or parameters for the part.

The method is performed in the order shown (top to bottom or numerical), but other orders may be used. For example, act 210 is performed prior to act 208. Additional, different, or fewer acts may be provided. For example, any combination of one, two, or all three acts 208, 210, and/or 212 are not performed, such as not performing any of acts 208, 210, and 212 where the application is to identify similar cases for reference. Act 208 may be combined with act 204, such as where the machine-learned self-attention model is trained to determine viability as an output where the training included self-attention similarity modeling using both regression and classification as pre-training.

In act 202, the processor receives information for a part. The process and state parameters for a manufactured device are received from transfer or accessing memory. The parameters for the manufactured device may be for a completely manufactured device or partly manufactured device.

Any format of data providing the process parameters and state parameters may be used. A spreadsheet or other format is provided for the variables and/or values for the process of manufacturing and/or the resulting state at one or more times during or after manufacture. The labels or tokens, such as identifiers of the device and/or components may be included. Other information, such as separators, start process indicators, end process indicators, and/or value ranges may be included.

The parameters are to be embedded. In one approach, the process and state parameters are embedded in a sequential tabulation. The process variables and process values for the process variables are included as the process parameters, and the state variables and state values for the state variables are included as the state parameters. The process parameters (e.g., variables) are for processing to form and/or test the device (e.g., manufacturing and testing), and the process values are the values of input or control in the process (e.g., voltage applied to form an emitter). The state parameters are for the state of the manufactured device during and/or after processing, such as size (e.g., thickness), density, modulus, or other characteristics. The same embedding includes these process and state parameters and may include additional, different, or fewer parameters.

In one embodiment for a component (e.g., cathode), the component is represented as an embedding of its process and state parameters. For example, formation of a cathode includes numerous sub-processes such as pre-forming of emitter, assembly of focusheads, final formation of emitter, microscopic analysis of the emitter, etc. Each of these processes gather and record values for a set of variables that describe physical parameters such as, how much voltage and current are applied and for how long. These are the process parameters. As a result of this process, the state of the cathode is altered through expansion of emitter, crystallization of emitter material, formation of grains, etc. These are the state parameters (e.g., state variables and corresponding measures as the state values). A sequential representation of such process and state parameters is the embedding. The process and state parameters included in the embedding may be different for different manufactured devices, different processes, and/or different states of interest.

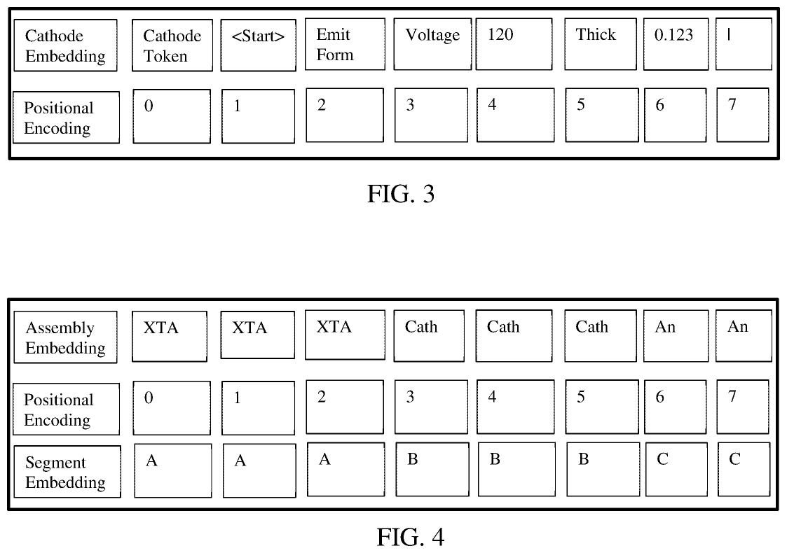

FIG. 3 shows an example of part of a cathode embedding. The embedding includes a first row as the process and state parameters. In this example, “cathode token” is a label designating the embedding as for a cathode and is included as a variable in the embedding. “<start>” is a process parameter indicating the beginning of the process for manufacturing the device. The “emit form” is a process name indicating formation of the emitter. The “voltage” is a process variable indicating the type of energy applied. “120” is a process value indicating the voltage applied. “Thick” is a state variable for thickness, and “0.123” is a state value for the thickness in any units. “I” is a separator indicating a different process with corresponding process and state parameters to follow. Additional, different, or fewer parameters may be embedded for this portion. Other variables, values, and/or labels may be included in other portions of the embedding.

The second row of the embedding is positional encoding. The process and state parameters are embedded with positional encoding. In this example, the positional encoding is a numerical integer starting at one value (e.g., 0) and counting up with each parameter. The sequence of occurrence of the processes is preserved via the positional encoding.

A given measurement may be repeated multiple times. The same process and/or state parameter(s) may be embedded multiple times. The positional encoding sequences through the multiple measurements or sub-labeling is used to indicate repetition of the same measurement multiple times (e.g., position 6 would be the first thickness measure, then position 7 would be assigned to the second thickness measure, and so on with the next parameter after the measurements than labeled with the next integer). For example, in cases where a particular measurement has to be repeated multiple times due to erroneous recordings in the previous attempts, this positional encoding helps to capture all the recordings without discarding the previous readings and implicitly uses them for similarity calculation. This avoids loss of information that can occur by considering only the latest measurements for modelling.

For an assembly, each of the multiple components are to be embedded. The process and state parameters for each component are embedded into a common embedding for the manufactured device. The different components are labeled in the common embedding. A two-level hierarchical embedding representation is provided. One level is for the components, and the other level is for the assembly. This two-level common embedding is then used to predict the viability (e.g., failure) of components and progressively check for indications of failure in the assembly when the components are healthy.

In the XTA example, each component (cathode, anode, etc.) of an XTA is represented as an embedding of its process and state parameters. The embedding is repeated for all components (e.g., embedding for cathode and embedding for anode). Once the components are classified as good, the next step is to concatenate these component embeddings to form the XTA embedding.

FIG. 4 shows an example portion of a common embedding for an assembly. Each entry in the top row is a different process or state parameter. For simplicity, XTA, Cath and An are indicated for XTA parameter, cathode parameter, and anode parameter, respectively. Many more of each type of parameter are included. The common embedding, for example, would include all of the positions and corresponding parameters for the cathode (FIG. 3 shows a portion). The columns for Cath show three parameters but would include more columns for the rest of the cathode parameters. Similarly, XTA and Anode columns would include additional assembly and anode process and state parameters.

The common or assembly embedding optionally has an additional row or layer called segment embedding. The segment embedding is used for providing the model with explicit differentiation between different components of the assembly or XTA. In the example of FIG. 4, A indicates XTA, B indicates Cathode, and C indicates anode. Numerical codes may be used. In other embodiments, the tokens for the components in the embedding row are used. The segment embedding allows for flexible modification of the embedding if there are new components being added to the XTA at a later time without requiring any changes to the architecture.

In one embodiment, a token is included as part of the embedding at a beginning of the embedding for each of the components. The token identifies the component, such as being a label. The process and state parameters for that component follow the token in the common embedding (see FIG. 3). Along with the segment embedding, each component embedding starts with a special token that is specific to that component. During inference time, this token can be retrieved for visualizing attention across different process parameters and values by component. For a failure prediction task, this attention can be leveraged for gaining insights into the parameters that influence the lifetime of the XTA based on the component.

The embedding places the process and state parameters as parameter variables and parameter values in a same space. Due to machine processing, the variables may use numerical representation of the text, such as ASCII. In other embodiments, the variables are encoded numerically with numerical values distinguishing from the parameter values. In order to represent both the process and/or state variables and values in the same embedding and in the same space, the variables are labeled using vocabulary identifiers starting from an arbitrarily high integer (for example 10001) such that any identifier less than 10001 is readily interpreted as a process or state value as opposed to a process or state variable. The vocabulary is assigned numerical identifiers to represent the text. Other encoding of the parameters may be used.

The embedding includes both continuous and non-continuous (categorical) representations. For example, the values are typically continuous, such as being numerical values in a range with any step size or resolution. Values may be non-continuous, such as representing different classes (e.g., curved or straight). Variables are typically non-continuous, such as being a discrete number of different variable names, so are provided as classes. Both continuous and non-continuous parameters are provided in the same embedding, whether an assembly embedding or a component embedding.

In act 204 of FIG. 2, the processor applies a machine-learned self-attention model to the process parameters and state parameters. The parameters with or without arrangement as an embedding are input to the machine-learned transformer neural network (e.g., transformer or tab transformer) or self-attention encoder neural network. The parameters are used to retrieve the most similar embeddings from historically available data by computing self-attention-based similarity. The machine-learned self-attention model is a neural network trained to perform identification of the similar embeddings using self-attention similarity. The machine-learned self-attention model may further include layers or network trained to determine viability from the similar embeddings and/or the input embedding. In an alternative embodiment, self-attention similarity is used in training the model to output viability where the model as trained receives the embedding and outputs viability based on self-attention without outputting similar cases (embeddings). The model is a self-attention model trained to implement the self-attention function during inference and/or by use of self-attention similarity in training.

Since the one input includes both continuous and non-continuous parameters, the machine-learned self-attention model was trained with regression for some of the process and/or state parameters and classification for others of the process and/or state parameters. In order to train the model, two training tasks: (i) masked value regression and (ii) masked variable classification are performed. Variables may be regressed, values may be classified, and/or non-masked approaches may be used.

FIG. 5 is a flow chart diagram of one embodiment of a method for machine training for similarity using self-attention. By training based on self-attention, the resulting machine-learned self-attention model operates differently than where trained without self-attention (e.g., using a different similarity). Similarly, by using regression and classification in training, the trained model operates differently. The weights, architecture, and/or learnable parameters may be different. By training based on self-attention, the model is trained to receive an embedding and generate the output.

For training, many samples of training data (e.g., samples of parameters and/or embeddings from a manufactured piece (e.g., device, part, component, or assembly)) are used. Ground truths are used for each sample. Where the model is trained to output an optimized embedding, then the ground truth is the embedding in a high dimensional space. The output embedding may be used to compare with other embeddings for other parts to identify similar ones. Where the model is trained to output similar cases, then the ground truth are the similar cases, such as identified through self-attention, other similarity matching, and/or manual identification. Where the model is trained to output viability, the ground truth is obtained from historical records for the similar cases. The similar cases are found through self-attention similarity.

Values for the learnable parameters of the neural network architecture are machine learned by optimization using the training data and ground truth. The transformer (e.g., self-attention-based encoder, tab transformer, or other transformer) architecture defines the learnable parameters. The optimization, such as Adam or gradient descent, determines the values of the learnable parameters of the architecture. Based on differences (i.e., losses) between output of the model being trained given the current possible values of the learnable parameters and the ground truths from different sample inputs (embeddings), the optimization minimizes the losses by varying the learnable parameters. The values of the learnable parameters resulting in an optimized or minimized loss or losses are then used as the trained model. In alternative embodiments, unsupervised training is used.

To deal with different types of information in the input, the training includes both regression and classification. Regression is used for any continuous parameters (e.g., all values or many of the values), and classification is used for any non-continuous parameters (e.g., all variables or many of the variables, and possibly some of the values). The same model (e.g., neural network) is trained with regression and classification. A different loss may be used for regression than for classification, such as softmax for classification and mean squared error loss for regression.

The training performs the regression of act 502 first, and then performs the classification of act 504 second. Alternatively, the order is reversed.

In act 502, the machine (e.g., processor) trains a neural network (e.g., transformer) with masked value regression to predict continuous values in an embedding including both the continuous values and non-continuous variables representing process and state parameters for a manufactured piece. The training task, masked value regression, randomly masks different parameters (e.g., parameter values) that are continuous in nature and trains the model to predict these values. The masking masks the continuous parameters one or multiples at a time to learn to predict the masked parameter(s). The masking pattern is random or systematic (e.g., start with lowest or highest spatial encoding and progress to the highest or lowest, respectively, for the continuous parameters). The regression loss is used to optimize all or some of the learnable parameters of the network. Other regression may be used.

During training for masked value regression, the masking does not cover the non-continuous parameters (e.g., variables). The model can actively use the context of surrounding parameter variables and other non-continuous parameters as they are all unmasked. The unmasked continuous parameters may be used as context.

The masked value regression uses a self-attention similarity. FIG. 6 represents the self-attention function or model with respect to a cathode embedding. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key. In practice, the attention function is computed on a set of queries simultaneously, packed together into a matrix Q. The keys and values are also packed together into matrices K and V. The attention score is computed by taking a dot product of Q and transposed K matrices, where each key is of dimension dₖ, and applying a softmax to obtain the weights on values.

In act 504 of FIG. 5, the machine trains the neural network with masked variable classification to predict the non-continuous parameters (e.g., variables) in the embedding. In the classification training task, the model is exposed to all or a window of the continuous or numerical values while randomly masking some (e.g., one) of the non-continuous parameters (e.g., variables). The same or different windowing and/or masking pattern as used in regression may be used, but oriented to the non-continuous parameters. Since these non-continuous parameters (e.g., variables) exist in a predefined vocabulary set, the model is trained for a classification task. This task is similar to “Masked Language Modeling” in Bidirectional Encoder Representations from Transformers (BERT).

The masked variable classification uses the self-attention similarity. The attention of FIG. 6 is used to learn to predict the class of the non-continuous parameters.

After both training for regression and classification, the machine-learned self-attention model is trained to predict an optimized representation of the input state and process parameters in the form of an embedding. During training, the model learns to represent data in the form of embedding via the regression and classification tasks. As the time of inference, the previously unseen cathode, anode, and XTA data is given as input, and the model outputs the embedding in a high dimensional space. This embedding is compared with historical embeddings, such as ones used in training, to identify the most similar one or more. The regression and classification may be pre-training in the sense that an additional training is performed for determining viability using the pre-trained model based on self-attention (e.g., use the similar ones or the predicted embedding to determine viability).

In act 506, the machine-trained neural network is stored. The values of the learnable parameters of the network architecture, the architecture, and values of any fixed parameters of the network architecture are stored. The storage is in a memory.

For inference, the machine-trained neural network is loaded from memory. The values of the learnable parameters are not changed for inference. A previously unseen data (e.g., cathode, anode and/or XTA data) is input to the machine-trained network. In response to the input, the machine-trained network outputs the embedding in a high dimensional space. The embedding is compared with other parts embeddings to identify similar parts. In alternative embodiments, the model may be trained to directly predict the viability or other trained output using, at least in part, the trained or pre-trained network for predicting the embedding.

Returning to FIG. 2, in act 206, the machine-learned self-attention model was trained with regression by masked value regression and was trained with classification by masked variable classification. The same model is trained for both regression and classification rather than having separate networks trained separately for regression and classification. The masked value regression masked continuous values to train the self-attention model to predict the masked continuous values, and the masked variable classification predicts masked parameter variables while exposing the continuous values to train the self-attention model to predict the masked parameter variables. The resulting trained network may generate output given input to the model (i.e., input layer of the neural network) of the embedding with both continuous and non-continuous parameters. The model was trained sequentially with the regression and with the classification.

In one embodiment, the training incorporated a discriminator. The machine-learned self-attention model was further trained as a generator of a generative adversarial network including a discriminator sequentially trained with the regression and with the classification. In this variant of the architecture, the model has a generator-discriminator block. In such a case, there is a third training or pre-training task for the discriminator to validate if the masked value regression and masked variable classification done by the generator are true. This discrimination may be used with other loss or as the loss for refining the training for regression and/or classification.

The output of the machine-trained self-attention model is an optimized embedding in a high dimensional space, which embedding may be used to identify historical examples. In other embodiments, the output is identification of or estimated samples of historical examples. The model, based on the self-attention similarity, outputs an embedding that may be used to identify historic examples (e.g., actual historical examples or estimates of historical examples), providing identification with self-attention-based similarity from application of the machine-learned self-attention model. The input is used to retrieve the most similar embeddings from historically available data by computing self-attention-based similarity performed by the machine-learned model. Other outputs may be provided, such as directly outputting the viability by the model based on the self-attention.

In act 208, the processor determines the viability of the manufactured device. The viability may be operability (e.g., faulty or not, or operable within tolerance or not), lifetime (i.e., expected lifespan), level of service (e.g., cost or amount), frequency of service, or other viability. For example, the processor predicts the failure of one or more components and/or the assembly. As another example, the processor progressively checks for indications of failure in the assembly when the components are healthy or in the components during manufacture and/or post manufacture based on on-going measurements or testing (e.g., further embedding).

The output of the machine-learned self-attention model is used to determine the viability. In response to application of the model to the embedding, the output is generated. The output may be used to determine the viability.

In one embodiment, the output includes historic examples or estimates of a historic example. The viability is determined from the historic examples. For example, an average or estimated lifespan is determined given the lifetimes of the identified similar examples. As another example, the estimated lifespan is output as part of the historic example (e.g., estimate or inferred historic example including viability). If the most similar embeddings retrieved from the past have failed, then the current cathode can be labeled as a potential failure or the time of failure is estimated. If the most similar embeddings have not failed, then the current cathode can be labeled as viable.

In another embodiment, a further model is trained to determine viability as an output given input. Training data of historical samples and ground truth viability collected from those devices are used to train the model to output viability in response to input of similar historical samples. The processor uses a machine-learned viability model (e.g., neural network) to infer the viability based on input of similar cases identified by applying the embedding to the machine-learned self-attention model.

In act 210, the processor identifies a subset of the process and/or state parameters based on influence on the viability. Some parameters have more affect than others on the viability. By varying the parameters and applying acts 204 and 208, the influence of the parameters on viability may be determined (e.g., little variation of one parameter may make a larger difference on viability than larger variation of another parameter).

For a part specific embedding, the variance is based on the embedding for that part. The parameters having a greatest effect on viability for a given part may be determined. Alternatively, the embedding for the part is compared to normal distributions of parameters oriented around known viable parts. Any parameter exceeding the norm of a given part is identified as influencing viability for that given part. This identification may be weighted by importance or correlation of the parameter with viability. By identifying one or more parameters adversely affecting the viability for the part, a fix or replacement component may be implemented or identified, respectively.

In act 212, the processor, using a display, generates an image. The image is text, graph, simulation of the part, or other representation of the viability. The viability is output.

Other information may be output. For example, the subset of process and/or state parameters most greatly influencing the viability in general or for a specific manufactured device are output with the viability. A part to be replaced or fix to alter the viability may be output as well or instead of the influencing parameters.

In alternative, or additional, embodiments, the manufacturing process is altered. For example, one or more process values are altered to manufacture the device in a way to increase viability. As another example, the device is automatically discarded, such as removing the device robotically from an assembly line.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for viability determination, the method comprising:
receiving process parameters and state parameters of a manufactured device;
applying a machine-learned self-attention model to the process parameters and state parameters, the machine-learned self-attention model having been trained with regression for some of the process and/or state parameters and classification for others of the process and/or state parameters;
determining viability of the manufactured device based on output of the machine-learned self-attention model in response to the applying; and
outputting the viability.

2. The method of claim 1 wherein determining the viability comprises determining a lifetime of the manufactured device.

3. The method of claim 1 wherein the manufactured device comprises a component of an x-ray tube assembly or the x-ray tube assembly.

4. The method of claim 1 wherein applying comprises outputting the output as an embedding as a sequential tabulation of process variables and process values for the process variables as the process parameters and of state variables and state values for the state variables as the state parameters, wherein the process variables comprise manufacturing and/or testing processes and the state variables comprises state of the manufactured device during and/or after processing to manufacture.

5. The method of claim 1 wherein applying comprises outputting the output as an embedding with one of more of the process parameters and/or state parameters represented multiple times.

6. The method of claim 1 wherein applying comprises outputting the output as an embedding with positional encoding of the process parameters and the state parameters.

7. The method of claim 1 wherein applying comprises outputting the output as an embedding for each of multiple components and embedding the process parameters and state parameters for each of the multiple components into a common embedding for the manufactured device with labels in the common embedding for the components.

8. The method of claim 7 wherein outputting further comprises including a token as part of the embedding at a beginning of the embedding for each of the components, the token identifying the component and the process and state parameters for that component following the token in the common embedding.

9. The method of claim 1 wherein applying comprises outputting the output as an embedding of the process and state parameters as parameter variables and parameter values in a same space with the variables encoded numerically with numerical values distinguishing from the parameter values and wherein the process and state parameters include both continuous and non-continuous representations.

10. The method of claim 1 wherein applying comprises applying with the machine-learned self-attention model comprising a transformer neural network.

11. The method of claim 1 wherein the machine-learned self-attention model was trained with regression by masked value regression and was trained with classification by masked variable classification.

12. The method of claim 11 wherein the masked value regression masked continuous values to train the self-attention model to predict the masked continuous values, and wherein the masked variable classification masked parameter variables while exposing the continuous values to train the self-attention model to predict the masked parameter variables.

13. The method of claim 11 wherein the machine-learned self-attention model was trained sequentially with the regression and with the classification.

14. The method of claim 13 wherein the machine-learned self-attention model was further trained as a generator of a generative adversarial network including a discriminator sequentially trained with the regression and with the classification.

15. The method of claim 1 wherein the output comprises an embedding based on self-attention based similarity, and wherein historic examples are identified with the embedding, and wherein determining comprises determining from the historic examples.

16. The method of claim 1 wherein determining comprises determining with a machine-learned viability model based on input of similar cases identified by the applying.

17. The method of claim 1 further comprising identifying a subset of the process and/or state parameters based on influence of the viability, wherein outputting the viability further comprises outputting the subset of the process and/or state parameters influencing the viability.

18. A system for similarity searching for a part, the system comprising:
a memory configured to store a machine-learned model, the machine-learned model comprising a transformer neural network configured to output an embedding based on self-attention similarity for both non-continuous variables and continuous values, the same transformer neural network having been trained with regression for the continuous values and classification for the non-continuous variables; and
a processor configured to apply the continuous values and the non-continuous variables for the part to the machine-learned model, the application resulting in inference by the machine-learned model of the embedding, wherein the processor is configured to find similar cases based on the embedding.

19. A method for machine training for similarity, the method comprising:
training, by a machine, a neural network with masked value regression to predict continuous values in an embedding including both the continuous values and non-continuous variables representing process and state parameters for a manufactured piece, the masked value regression using a self-attention similarity;
training, by the machine, the neural network with masked variable classification to predict the non-continuous variables in the embedding, the masked variable classification using the self-attenuation similarity; and
storing the machine-trained neural network.

20. The method of claim 19 wherein training with masked value regression comprises training with the non-continuous variables exposed, and wherein training with the masked variable classification comprises training with the continuous values exposed, the neural network comprises a transformer network as a self-attention-based encoder.
